(19) United States
(12) Patent Application Publication
(10) Pub. No.: US 2021/0284316 A1
(43) Pub. Date: Sep. 16, 2021

(54) CLOGGING AND FOULING RESISTANT MARINE POWER GENERATING SYSTEM

(71) Applicant: Pauli Olavi Kuoppamaki, Fuengirola (ES)

(72) Inventor: Pauli Olavi Kuoppamaki, Fuengirola (ES)

(21) Appl. No.: 16/347,469

(22) PCT Filed: May 3, 2019
(86) PCT No.: PCT/US19/30512

§ 371 Date: May 3, 2019

Related U.S. Application Data
(60) Provisional application No. 62/667,646, filed on May 7, 2018.

(51) Int. Cl. B63J 3/04; F03B 13/24; H02K 7/18

(52) U.S. Cl. CPC B63J 3/04; F03B 13/24; H02K 7/1823; F05B 2240/931; F05B 2220/602; F05B 2240/133; B63J 2003/046

(57) ABSTRACT

A power generating system for sailboats and sailing vessels employing the vacuum provided by a Venturi generator while the boat or vessel is in motion. Placement of a turbine for recovering the energy of air moving from the atmosphere to the throat of the Venturi generator in a duct leading from above deck to the Venturi generator. A variety of methods for generating the required vacuum while avoiding fouling of moving parts and clogging by debris in the water.

This application claims the benefit of U.S. Provisional Patent Application No. 62/667,646, filed May 7, 2018, which is incorporated by reference herein in its entirety.

### BACKGROUND OF THE INVENTION

### 1. Field of the Invention

This invention relates to the field of marine power generation. More specifically, the invention comprises benefiting from the movement of a vessel through water for the purpose of running an electrical generator without the potential risk of clogging or fouling the turbine and associated ductwork in less than pure waters.

### 2. Description of the Related Art

Ships and power boats typically use engine power for electric generation. Sailboats, like possible future sail-powered ships, have the choice of temporary use of the auxiliary engine, a separate fuel-powered generator, solar panels, wind turbines, and towable marine generators. Crews may want to save on fuel; the sun may not shine; wind turbines may be considered dangerous and vulnerable to high winds. These and other reasons may make it desirable to take advantage of the vessel's movement through the water for generating electric power. At the cost of a certain amount of drag, this can be done with a towable marine generator.

The invention addresses a potential problem with towable generators. Their propellers, like other parts below the water line, are subject to fouling. With the growing presence of floating garbage in the seas, the propellers of such generators become more susceptible to clogging and snagging, adding to the existing problems from seaweed and other debris. Protecting them with propeller guards and screens only transfers the problem, it doesn't solve it. The invention removes the propeller from the water and eliminates the problems just mentioned.

### BRIEF SUMMARY OF THE PRESENT INVENTION

The present invention comprises a Venturi vacuum generator below the vessel, designed and located with a view to minimal interference with the normal movement of the vessel through the water. Additionally, the invention comprises routing a duct from the outside air to the throat of the Venturi generator, where a vacuum is formed when the vessel is in motion, and incorporating a turbine into this duct, whereby a fraction of the energy obtained from the wind for moving the vessel through the water can be recovered—typically in the form of electrical current by attaching a generator to the turbine.

A classic Venturi vacuum generator consists of an entry cone, a throat, and an exit cone. One or more such tubular units mounted below the vessel are suited for powering the present invention where clogging is not an issue. The Venturi tube can also be built into the lower part of the vessel's hull. Alternatively, if the vessel is to be used in waters where clogging has to be prevented, its bottom can be designed to produce a vacuum either on its own—e.g., by using a step—or in combination with one or more retractable foils simulating a Venturi tube either on their own or in concert with the shape of the hull. Said foil or foils can temporarily be retracted into the body of the vessel when accumulated debris begins to interfere with power generation, permitting them to shed such debris and be re-extended immediately.

The turbine and its load, typically an electric generator, are entirely enclosed within the body of the vessel and are thus protected from water, weather, and contamination. Contrary to a towable generator, no part of the gear forming the invention protrudes behind the vessel, eliminating the necessity to recover it when docking, and protecting it against objects moving near the vessel.

### BRIEF DESCRIPTION OF THE SEVERAL VIEWS OF THE DRAWINGS

FIG. 1 is a process flow diagram, showing the functional principle of the present invention.

FIG. 2 shows a side view of a boat equipped with an external Venturi tube embodiment of the invention.

FIG. 3 is a plan view of the same embodiment.

FIG. 4 is a cross-section of the same embodiment.

FIG. 5 shows a side view of a boat equipped with a multiple foil embodiment of the invention.

FIG. 6 is a plan view of the same embodiment.

FIG. 7 is a cross-section of the same embodiment.

FIG. 8 is a side view of a boat equipped with a single-foil embodiment of the invention.

FIG. 9 is a plan view of the same embodiment.

FIG. 10 is a cross-section of the same embodiment.

FIG. 11 shows a side view of an embodiment where the vacuum is generated by a stepped hull.

FIG. 12 is a plan view of the same embodiment.

FIG. 13 is a cross-section of the same embodiment.

FIG. 14 illustrates the step hull embodiment augmented by a semicircular foil booster.

FIG. 15 is a plan view of the same embodiment.

FIG. 16 is a cross-section of the same embodiment.

FIG. 17 shows a side view of a boat equipped with an internal Venturi tube embodiment of the invention.

FIG. 18 is a plan view of the same embodiment.

FIG. 19 is a cross-section of the same embodiment.

### REFERENCE NUMERALS IN THE DRAWINGS

1 Hull

2 Air intake

3 Connecting duct between air intake and turbine/generator

4 Turbine/generator

5 Venturi throat

6 Connecting duct between turbine/generator and Venturi throat

7 Air outlet(s) to the throat of the Venturi generator

8 Foil/foils shaped for generating Venturi effect

9 Hull step

10 Vacuum relief valve

11 Control panel

12 Air outlet(s) at the throat of the step

13 Connecting duct between turbine/generator and step throat

14 Water Intake to Venturi throat

15 Water outlet from Venturi throat

16 Venturi tube

17 Process start

18 Process end, Electrical supply connector

19 Process end, Vacuum supply connector

20 Three way valve

### DETAILED DESCRIPTION OF THE INVENTION

The drawings show the principle of the invention and its application in several different embodiments, where the vacuum generation is performed in various ways.

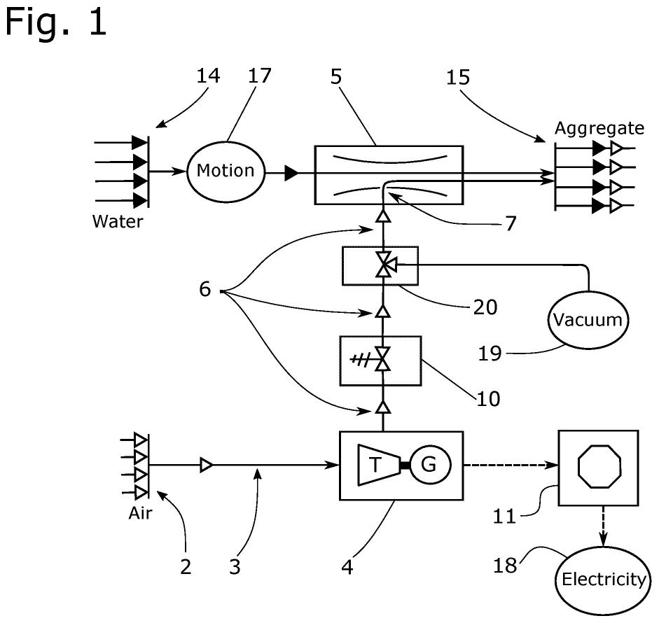

FIG. 1 is a process flow diagram, showing the functional principle of the present invention. When the boat is in motion 17, a vacuum is formed in the throat 5 of the Venturi generator. A duct or set of ducts 6 placed between the turbine/generator 4 and outlets 7 to the Venturi throat 5 impels air supplied by the air intake 2 through the connecting duct 3 and powers the turbine/generator 4. A vacuum relief valve 10 and a three way valve 20 are placed in duct 6 between the turbine/generator 4 and air outlets 7 at the throat of the Venturi generator.

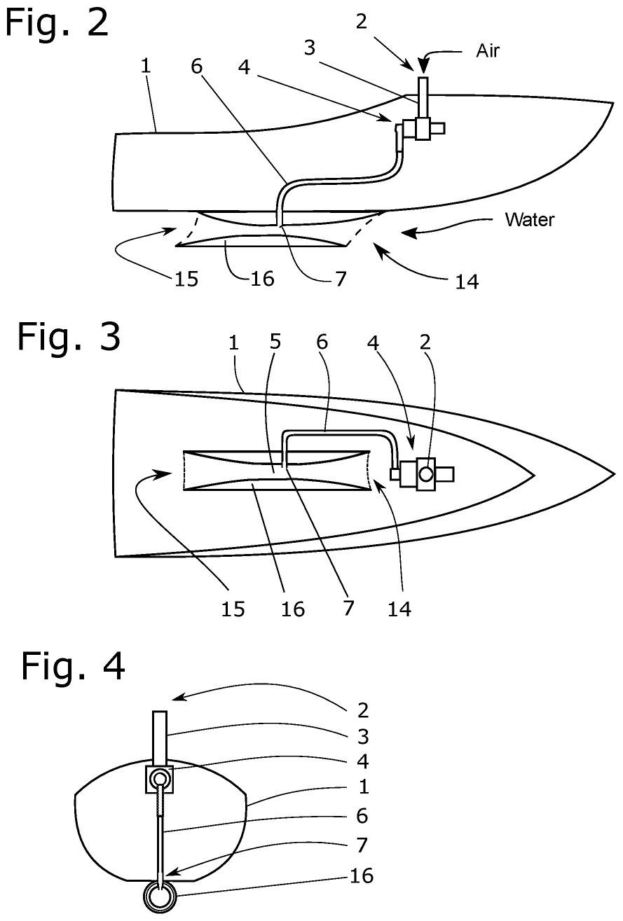

FIG. 2 is a side view of a boat, showing the external Venturi tube embodiment of the present invention. The same embodiment is shown as a plan view in FIG. 3 and as a cross-section in FIG. 4. When the boat is in motion, a vacuum is formed in the throat 5 of the Venturi tube 16. A duct or set of ducts 6 placed between the turbine/generator 4 and outlets 7 to the Venturi throat 5 impels air supplied by the air intake 2 through the connecting duct 3 and powers the turbine/generator 4. The amount of power thus generated will depend on the speed of the vessel and a number of design variables that will have to be theoretically and empirically optimized for each type of vessel where the invention is to be implemented.

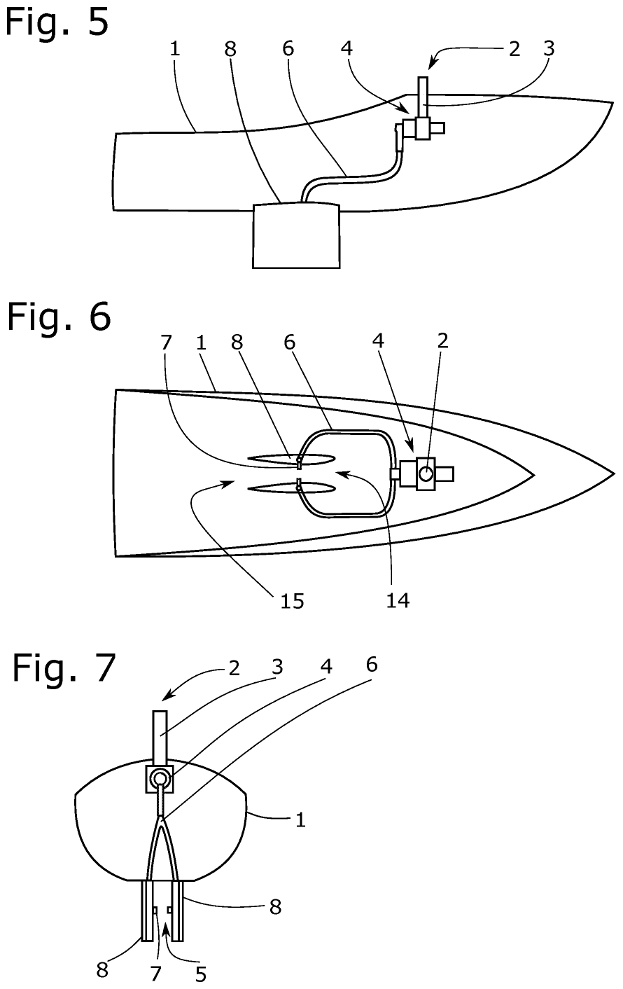

FIG. 5 is a side view of a boat, showing the multiple foil embodiment of the present invention. The same embodiment is shown as a plan view in FIG. 6 and as a cross-section in FIG. 7. When the boat is in motion, a vacuum is formed in the throat between the two retractable foils 8. These foils, by virtue of their cross-section, as indicated in FIG. 6, act as a two-dimensional Venturi generator. A duct or set of ducts 6 placed between the turbine/generator and outlets 7 to the Venturi throat 5 impels air supplied by the air intake 2 through the connecting duct 3 and powers the turbine/generator 4.

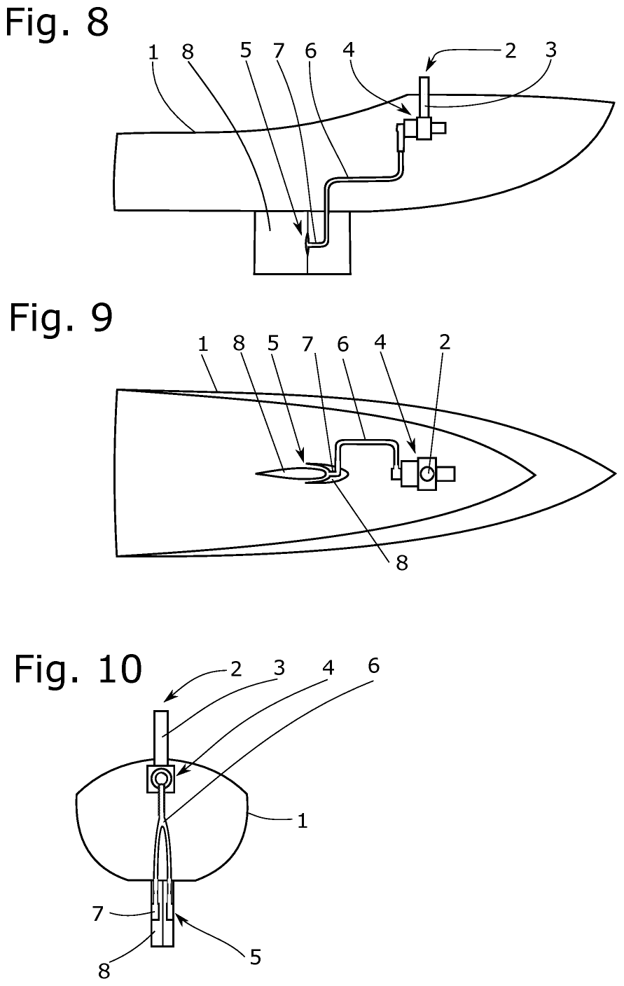

FIG. 8 is a side view of a boat, showing the single foil embodiment of the present invention. The same embodiment is shown as a plan view in FIG. 9 and as a cross-section in FIG. 10. The working principle is exactly the same as described above. Research and development work will determine which foil design is best from the points of view of speed, power generation, maneuverability, draft, etc.

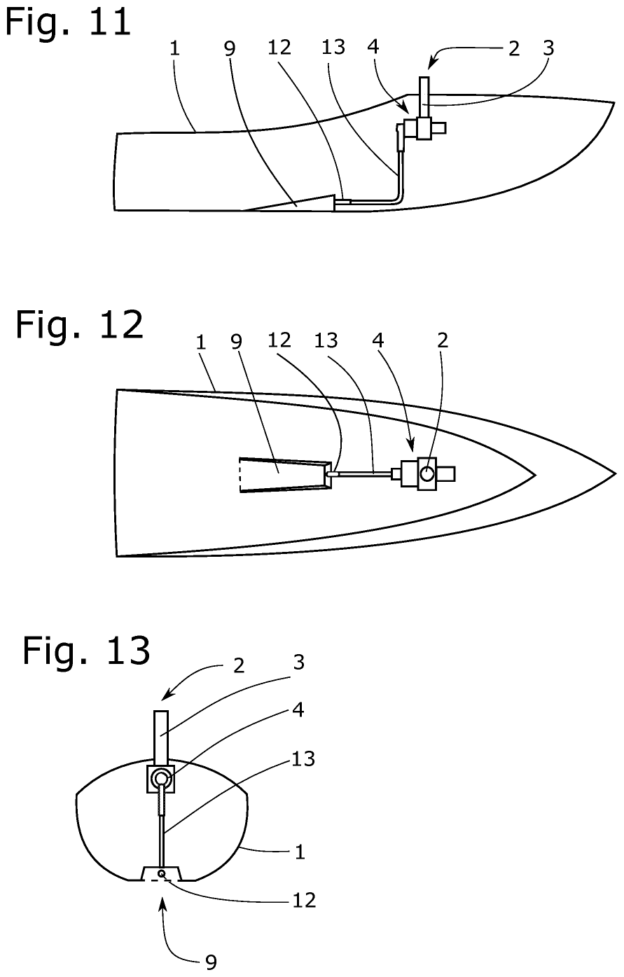

FIG. 11 shows the same principle in an embodiment where the vacuum is generated by a stepped hull. The same embodiment is shown as a plan view in FIG. 12 and as a cross-section in FIG. 13. Air supplied by the connecting duct 13 from the turbine/generator to an outlet 12 at the throat of the step 9 replaces or complements the venting normally used for stabilizing a stepped hull.

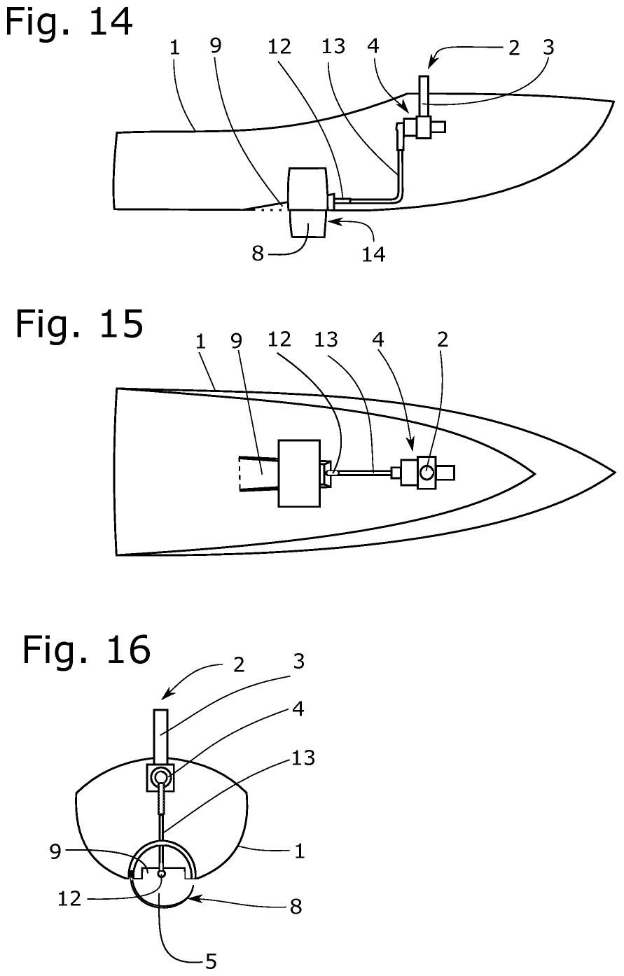

FIG. 14 illustrates the step hull embodiment augmented by a semicircular foil 8 acting as a booster for the vacuum generation in the hull step 9. The same embodiment is shown as a plan view in FIG. 15 and as a cross-section in FIG. 16. Like the straight foils described above, the semicircular foil can be temporarily retracted into a similarly shaped chamber in the hull when it needs to be cleared of debris.

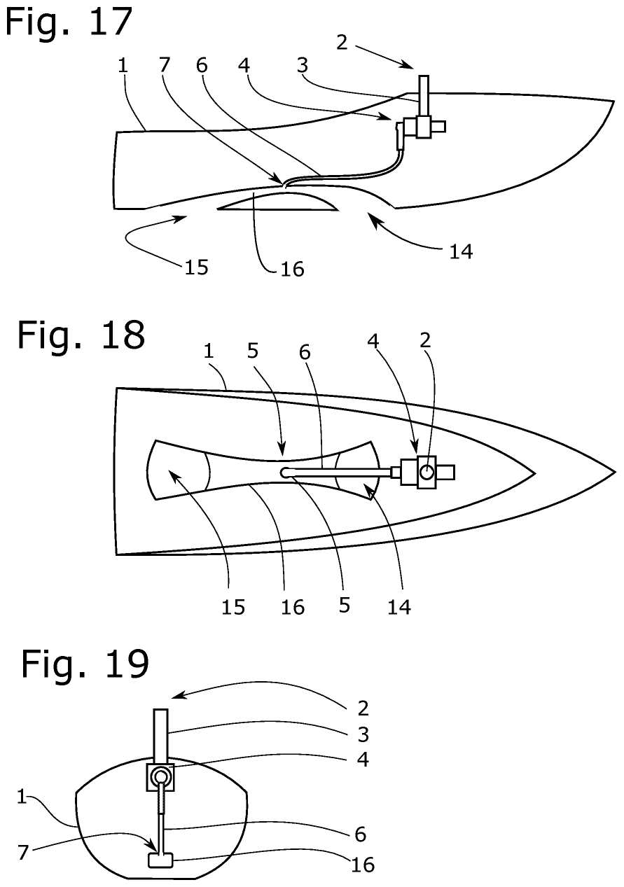

FIG. 17 is a side view of a boat, showing the internal Venturi tube embodiment of the present invention. The same embodiment is shown as a plan view in FIG. 18 and as a cross-section in FIG. 19. The working principle is exactly the same as described above. The internal Venturi tube embodiment may be advantageous where clogging is not an issue but the draft of the vessel must be minimized.

Having described my invention, I claim:

1. A power generating system for sailboats and sailing vessels consisting of an air-driven turbine/generator assembly mounted in a duct between the outside air and the throat of a venturi vacuum generator under the vessel, comprising:
(a) a venturi generator or eductor, or a step, below the vessel creating a vacuum while the vessel moves forward through water at sufficient speed;
(b) a duct from the throat of the venturi generator or eductor, or the step, to the outside air;
(c) a turbine/generator assembly inserted into said duct;
(d) necessary wiring and circuitry for utilizing the generated electricity.

2. A power generating system for sailboats and sailing vessels as recited in claim 1, wherein the venturi vacuum generator can be a hull step, a venturi tube, a similarly shaped space formed between the hull and/or retractable foils as occasioned by the absence or presence of debris in the waters where the invention will be used, one or more venturi eductors similar to those used for self-bailing devices, or a combination of such designs.

3. A power generating system for sailboats and sailing vessels as recited in claim 1, wherein the principle of energy recovery by means of a turbine inserted into a duct feeding air to a vacuum generated by the movement of the vessel through water is used, irrespective of the location of the air outlet of said duct in the water around the vessel, the precise means of generating said vacuum at that location, and the precise form of recovering said energy.

4. A power generating system for sailboats and sailing vessels as recited in claim 1, where, by utilizing suitable controls and run-time adjustments, the steering of the vessel can be affected as desired by varying the relative resistance against the flow of ambient water of two or more venturi generators mounted in parallel along the two sides of the vessel.
